(19) United States
(12) Patent Application Publication
(10) Pub. No.: US 2013/0157505 A1
(43) Pub. Date: Jun. 20, 2013

(54) COAXIAL CONNECTOR

(71) Applicants: Michael Timothy Sykes, Mechanicsburg, PA (US); Jie Qin, Hummelstown, PA (US); Keith Richard Foltz, Duncannon, PA (US); Kevin Weidner, Hummelstown, PA (US)

(72) Inventors: Michael Timothy Sykes, Mechanicsburg, PA (US); Jie Qin, Hummelstown, PA (US); Keith Richard Foltz, Duncannon, PA (US); Kevin Weidner, Hummelstown, PA (US)

(73) Assignee: Tyco Electronics Corporation, Berwyn, PA (US)

(21) Appl. No.: 13/428,981

(22) Filed: Mar. 23, 2012

Related U.S. Application Data
(63) Continuation-in-part of application No. 13/330,874, filed on Dec. 20, 2011.
Application No. 13/330,874 is a continuation-in-part of application No. 13/330,978, filed on Dec. 20, 2011.

(51) Int. Cl. H01R 9/05

(52) U.S. Cl. 439/578

(57) ABSTRACT

A coaxial connector including a socket contact having a mating end, a terminating end, and a central contact axis extending therebetween. The socket contact includes a contact wall that extends around the contact axis and defines a contact cavity. The contact wall has a wall edge at the mating end that defines a contact opening to the contact cavity. The coaxial connector also includes a dielectric insert that holds the socket contact. The dielectric insert includes a mating face that has an insert opening providing access to the bore. The dielectric insert includes a body portion that surrounds the socket contact and a hood portion that defines the insert opening. The hood portion projects radially inward from the body portion so that the hood portion covers the wall edge. The hood portion is configured to direct a pin contact of a mating connector into the contact cavity.

### CROSS REFERENCE TO RELATED APPLICATIONS

The present application is a continuation-in-part of U.S. patent application Ser. Nos. 13/330,874 and 13/330,978, both of which were filed on Dec. 20, 2011. Each of the above applications is incorporated by reference in its entirety.

### BACKGROUND OF THE INVENTION

The subject matter herein relates generally to coaxial connectors.

A typical coaxial connector, such as a subminiature version A (or SMA) connector, has a metal outer shell, an inner dielectric insert, and a center contact to carry the signal. The center contact is secured within a central bore of the inner dielectric insert. Coaxial connectors may be either terminated to a cable or terminated to a printed circuit board (PCB). Coaxial connectors may be either plug connectors or jack connectors of either standard or reverse polarity configurations. The plug and jack connectors are configured to mate with each other during a mating operation. For example, the center contact of the plug connector may be a pin contact, and the center contact of the jack connector may be a socket contact having a cavity that is sized to receive the pin contact. When the pin contact is received into the cavity, the pin contact engages interior walls of the socket contact.

However, typical coaxial connectors are not without disadvantages. For instance, during the above-described mating operation, the pin and socket contacts may engage each other in a misaligned manner. To withstand these forces without damage to the pin and socket contacts, the contacts are manufactured thicker than what is sufficient for transmitting the data signals. Due to the sizes of the contacts, the pin and socket contacts are typically screw-machined. However, the process of screw-machining may be more expensive than other manufacturing processes and typically results in more wasted material.

Accordingly, there is a need for coaxial connectors having center contacts that are less costly than known center contacts.

### BRIEF DESCRIPTION OF THE INVENTION

In one embodiment, a coaxial connector is provided that includes a socket contact having a mating end, a terminating end, and a central contact axis extending therebetween. The socket contact includes a contact wall that extends around the contact axis and defines a contact cavity. The contact wall has a wall edge at the mating end that defines a contact opening to the contact cavity. The coaxial connector also includes a dielectric insert having a central bore that receives and holds the socket contact. The dielectric insert includes a mating face that has an insert opening providing access to the bore. The dielectric insert includes a body portion that surrounds the socket contact and a hood portion that defines the insert opening. The hood portion projects radially-inward from the body portion toward the contact axis so that the hood portion covers the wall edge. The hood portion is configured to direct a pin contact of a mating connector into the contact cavity.

In another embodiment, a coaxial connector is provided that includes a pin contact having a mating end, a terminating end, and a central contact axis extending therebetween. The pin contact includes a barrel section and a head section of the pin contact. The head section is configured to be received by a socket contact of a mating connector. The pin contact is shaped such that the barrel section has an external diameter that is greater than an external diameter of the head section. The coaxial connector also includes a dielectric insert having a central bore that receives and holds the pin contact. The dielectric insert has a mating face that includes an insert opening providing access to the bore. The head section of the socket contact extends through the insert opening and projects away from the mating face along the contact axis. The dielectric insert includes a body portion that surrounds the pin contact and a hood portion that defines the insert opening. The hood portion projects radially inward from the body portion toward the contact axis. The hood portion directly surrounds the head section of the pin contact.

In a further embodiment, a coaxial connector system is provided that includes a first coaxial connector having a first dielectric insert with a mating face and a socket contact that is held by the first dielectric insert. The mating face includes an insert opening that permits access to the socket contact. The first coaxial connector also includes a first outer contact that surrounds the first dielectric insert and the socket contact. The first outer contact includes a main portion and an end portion. The connector system also includes a second coaxial connector having a second dielectric insert with a mating face and a pin contact that is held by the second dielectric insert. The first coaxial connector also includes a second outer contact that surrounds the second dielectric insert and the pin contact. The second outer contact includes a main portion and an end portion. The socket contact is configured to receive and engage the pin contact when the first and second coaxial connectors are mated. The end portions of the first and second outer contacts engaging and electrically coupling to each other at an interface, wherein the end portions include respective contact rims that project radially inward toward the contact axis. The contact rims are configured relative to the pin and socket contacts and the first and second dielectric inserts to maintain a target impedance.

### BRIEF DESCRIPTION OF THE DRAWINGS

FIG. 1 illustrates a family of coaxial connectors that may be mated to form coaxial connector systems according to exemplary embodiments.

FIG. 2 is a front exploded view of a plug connector formed in accordance with an exemplary embodiment.

FIG. 3 is a side cross-section of the plug connector shown in FIG. 2.

FIG. 4 is a front exploded view of a jack connector formed in accordance with an exemplary embodiment.

FIG. 5 is a side cross-section of the jack connector shown in FIG. 4.

FIG. 6 is a perspective view of a socket contact formed in accordance with an exemplary embodiment.

FIG. 7 is a side cross-section of a pin contact formed in accordance with an exemplary embodiment.

FIG. 8 is a side cross-section of a coaxial connector system formed in accordance with an exemplary embodiment.

FIG. 9 is an enlarged portion of the connector system shown in FIG. 8 that illustrates in greater detail a mating interface between coaxial connectors of the connector system.

FIG. 10 is an enlarged portion of the connector system shown in FIG. 8 illustrating in greater detail a pin contact engaged to the socket contact.

FIG. 11 is a side view of a mating end of the pin contact.

### DETAILED DESCRIPTION OF THE INVENTION

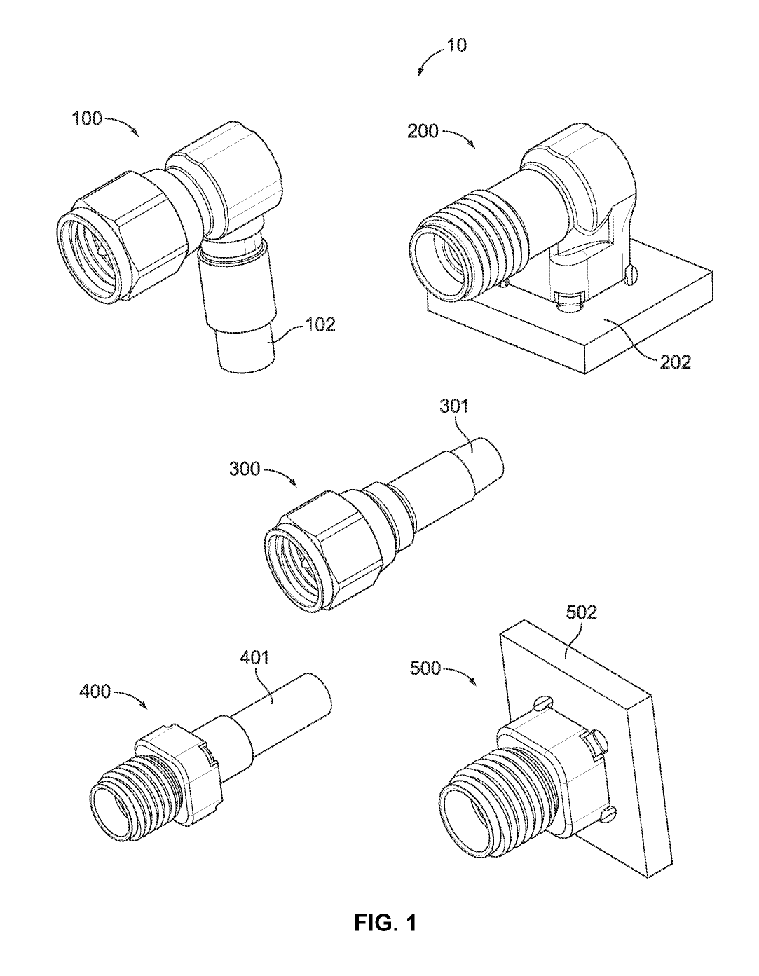

FIG. 1 illustrates a coaxial connector system 10 formed in accordance with an exemplary embodiment. The coaxial connector system 10 may use different types of plug and jack coaxial connectors, such as different combinations of cable-mounted connectors and board-mounted connectors and/or different combinations of in-line and right-angle connectors. The plug connectors are configured to mate with or engage the jack connectors during mating operations. The connections between the coaxial connectors may be cable-to-cable, board-to-board, or cable-to-board connections. Embodiments described herein include coaxial connectors and coaxial connector systems that are at least one of configured to control impedance, configured for a predetermined electrical performance, and/or configured to protect the contacts from damage during a mating operation. In some embodiments, the coaxial connectors described herein may include stamped-and-formed contacts.

Exemplary embodiments of versions of such connectors are illustrated in FIG. 1. FIG. 1 shows a right-angle, cable-mounted plug connector 100; a right-angle, board-mounted jack connector 200; an in-line, cable-mounted plug connector 300; an in-line, cable-mounted jack connector 400; and an in-line, board-mounted jack connector 500. The plug connector 100 is terminated to a coaxial cable 102. The jack connector 200 is terminated to a circuit board 202. The plug connector 300 is terminated to a coaxial cable 301. The jack connector 400 is terminated to a coaxial cable 401. The jack connector 500 is terminated to a circuit board 502. The plug connectors 100, 300 are configured to be threadably coupled to one of the jack connectors 200, 400, 500 using internal threads on the plug connectors 100, 300 and external threads on the jack connectors 200, 400, 500. Alternative coupling means may be used in alternative embodiments.

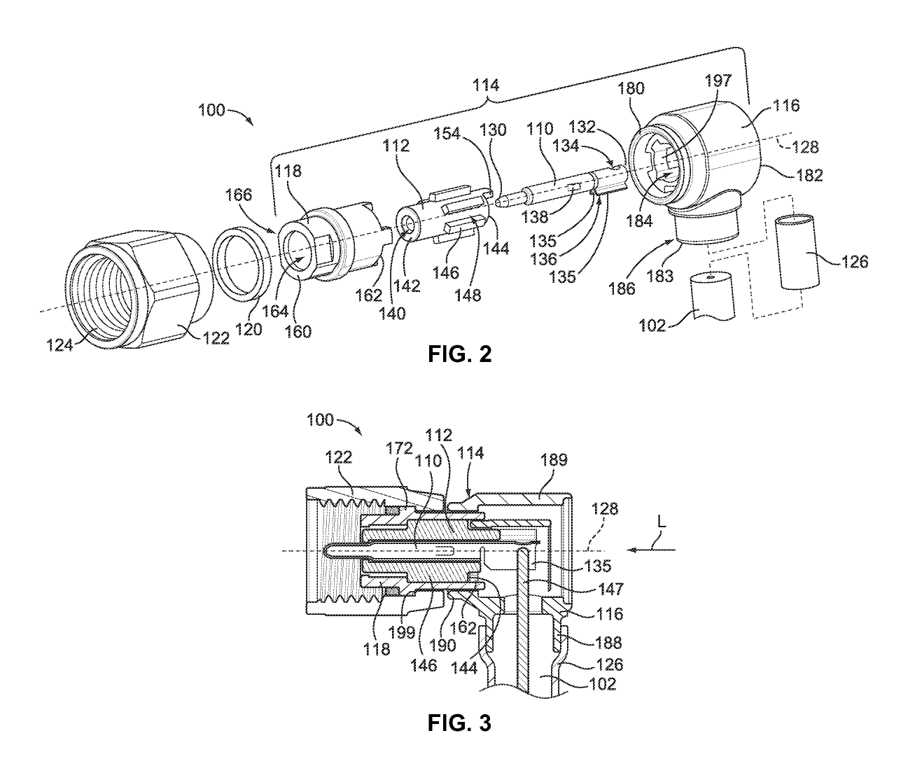

FIG. 2 is a front exploded view of the plug connector 100. The plug connector 100 includes a center contact 110, a front dielectric insert 112 that is configured to hold the center contact 110, and an outer contact 114 that receives the dielectric insert 112 and the center contact 110. The center contact 110 is configured to be terminated to a center conductor 147 (shown in FIG. 3) of the coaxial cable 102 (FIG. 1), either through a direct engagement between the center contact 110 and the center conductor 147 or indirectly through a separate pin contact (not shown) terminated to the end of the center conductor 147 that is then directly connected to the center contact 110. In the illustrated embodiment, the center contact 110 is a pin contact and is hereafter referred to as the pin contact 110. However, in alternative embodiments, the plug connector 100 may use a socket contact instead of the pin contact 110. The outer contact 114 is configured to be electrically connected to an outer conductor or cable shield (not shown) of the coaxial cable 102, such as by crimping or soldering to the cable shield.

As shown in FIG. 2, the outer contact 114 may be a multi-piece body formed from a rear housing 116 and a front housing 118. In the illustrated embodiment, the front housing 118 defines a plug housing and may be referred to hereinafter as the plug housing 118. The rear housing 116 may be a single-piece housing or may be a multi-piece housing. The plug connector 100 also includes a gasket 120 that is configured to be coupled to the plug housing 118 to seal against the jack connector 200 (FIG. 1) when mated thereto. The plug connector 100 may also include a coupling nut 122 that is configured to be rotatably coupled to the plug housing 118. The coupling nut 122 has internal threads 124 for securing the plug connector 100 to the jack connector 200.

The plug connector 100 includes a crimp barrel 126 that is configured to be coupled to the rear housing 116. The crimp barrel 126 is used to crimp the plug connector 100 to the coaxial cable 102. The crimp barrel 126 serves to mechanically and electrically connect the plug connector 100 to the coaxial cable 102.

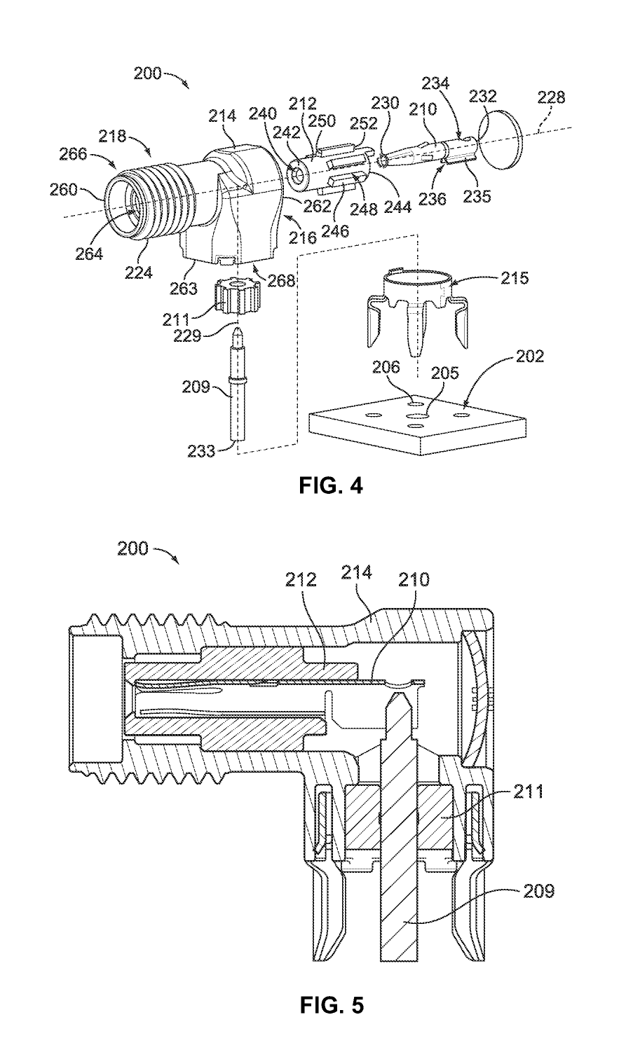

The pin contact 110 extends along a central contact axis 128 between a separable interface end or mating end 130 of the pin contact 110 and a non-separable terminating end 132 of the pin contact 110. The mating end 130 is configured to be mated with a corresponding socket contact 210 (shown in FIG. 4) of the jack connector 200 when the plug connector 100 is coupled thereto. Optionally, the pin contact 110 may be selectively plated at the mating end 130 to enhance the performance and/or conductivity of the separable interface. The mating end 130 defines a pin, however the mating end 130 may have a different configuration in an alternative embodiment. For example, the mating end 130 may faun a socket. In such embodiments, the plug connector 100 may define a reverse polarity connector. In an exemplary embodiment, the pin contact 110 is a stamped-and-formed contact.

The terminating end 132 is configured to be terminated to the center conductor 147 (FIG. 3) of the coaxial cable 102. In an exemplary embodiment, the pin contact 110 has an open-sided barrel 134 at the terminating end 132. The barrel 134 is configured to receive the center conductor 147 therein. Alternatively, the barrel 134 may receive another contact, such as a cable pin of the coaxial cable 102 (e.g., pin contact), that is terminated to the end of the conductor. In an exemplary embodiment, the barrel 134 includes a pair of paddles 135 opposing one another and separated by a gap 136. The center conductor 147 is received in the gap 136 between the paddles 135. The paddles 135 press against the center conductor 147 to create an electrical connection therewith. In other alternative embodiments, the pin contact 110 may be terminated to the center conductor 147 by other processes or methods, such as crimping, indenting, lancing, active beam termination, insulation displacement connection, and the like. Also shown, the pin contact 110 includes locking tabs 138 extending therefrom. The locking tabs 138 are deflectable and are configured to secure the pin contact 110 in the dielectric insert 112.

The front dielectric insert 112 is manufactured from a dielectric material, such as a plastic material. The dielectric material may be a composite material. The dielectric insert 112 has a central bore 140 extending therethrough that receives and holds the pin contact 110. The dielectric insert 112 extends between a mating face 142 and a rear 144. The bore 140 may extend entirely through the dielectric insert 112 between the mating face 142 and the rear 144. The bore 140 extends axially along the contact axis 128 of the plug connector 100.

The dielectric insert 112 is generally tubular in shape and includes a plurality of structural features 146, such as wings or tabs, extending radially outward from an exterior of the tubular dielectric insert 112. In an exemplary embodiment, the structural features 146 extend axially along an exterior of the dielectric insert 112. Air gaps 148 are defined between the structural features 146 and introduce air (another type of dielectric) in the isolation area around the pin contact 110. In the illustrated embodiment, the structural features 146 extend only partially along the dielectric insert 112. In the illustrated embodiment, the structural features 146 are located proximate to the rear 144, however the structural features 146 may be located at any axial position along the dielectric insert 112.

The structural features 146 are used to secure the front dielectric insert 112 within the outer contact 114. In an exemplary embodiment, the dielectric insert 112 is received within the plug housing 118 and the structural features 146 engage the plug housing 118 to secure the dielectric insert 112 in the plug housing 118. The structural features 146 may engage the outer contact 114 and hold the dielectric insert 112 by an interference fit therein.

In an exemplary embodiment, the size and shape of the structural features 146 are selected to provide a desired dielectric constant of the dielectric between the pin contact 110 and the outer contact 114. When the pin contact 110 and dielectric insert 112 are loaded into the outer contact 114, the pin contact 110 is electrically isolated from the outer contact 114 by the material of the dielectric insert 112 and by air. The air and the dielectric insert 112 constitute the dielectric between the pin contact 110 and the outer contact 114. The dielectric constant is affected by the amount of material of the dielectric insert 112 as well as the amount of air. The material of the dielectric insert 112 has a dielectric constant that is greater than the dielectric constant of air. By selecting the size and shape of the dielectric insert 112, including the structural features 146, the impedance of the plug connector 100 may be tuned, such as to achieve an impedance of 50 Ohms or another target impedance. For example, a design having more plastic in the isolation area between the outer contact 114 and the pin contact 110 (e.g., a thicker tube, wider structural features 146, more structural features 146, longer structural features 146, and the like) may decrease the impedance, whereas providing more air may increase the impedance.

In an exemplary embodiment, the dielectric insert 112 includes an extension 154 extending rearward from the dielectric insert 112. The extension 154 may be located generally along the top of the pin contact 110 when loaded into the dielectric insert 112. The extension 154 may extend into the rear housing 116 when the plug connector is assembled. The extension 154 may be positioned between the pin contact 110 and the rear housing 116 to position a predetermined amount of dielectric material between the pin contact 110 and the rear housing 116, so as to control the impedance of the signal path along the extension 154.

The plug housing 118 extends between a front 160 and a rear 162. The plug housing 118 has a main cavity 164 extending between the front 160 and the rear 162. The main cavity 164 receives the dielectric insert 112 and the pin contact 110. In an exemplary embodiment, the front 160 of the plug housing 118 defines a separable interface end 166 of the outer contact 114. The rear 162 of the plug housing 118 is configured to be coupled to the rear housing 116.

The rear housing 116 is configured to be interchangeably coupled to the plug housing 118 with other differently sized/shaped rear housings, such as to mate to differently sized cables. The rear housing 116 includes a front 180 and a rear 182. The rear housing 116 includes a bottom 183. The bottom is oriented generally perpendicular with respect to the front 180 and the rear 182. A cavity 184 extends through the rear housing 116. The cavity 184 makes a 90° bend within the rear housing 116. The cavity 184 is open at the front 180, the rear 182 and the bottom 183. The bottom 183 of the rear housing 116 defines a terminating end 186 of the outer contact 114. When the rear housing 116 is coupled to the plug housing 118, the terminating end 186 is oriented generally perpendicular with respect to the separable interface end 166. The plug connector 100 defines a right angle or 90° connector. The coaxial cable 102 extends generally at a right angle or 90° with respect to the pin contact 110. The signal path through the plug connector 100 is changed along the right angle path.

The rear housing 116 includes an inner shield 197 in the cavity 184 and/or defining part of the cavity 184. The inner shield 197 may be integrally formed with the rear housing 116, such as during a common molding or forming process. Alternatively, the inner shield 197 may be separate from the rear housing 116 and loaded into the rear housing 116. The inner shield 197 may be shaped complementary to the shape of the barrel 134 of the pin contact 110, with the inner shield 197 being spaced apart from the barrel 134 by a predetermined distance selected to control the impedance of the signal path through the plug connector 100. The size and shape of the inner shield 197 may be selected to tune or control the impedance, such as to achieve a target impedance along such portion of the rear housing 116. For example, the size and shape of the inner shield 197 may be selected to allow a certain volume of air to be positioned between the inner shield 197 and the pin contact 110.

FIG. 3 is a cross-sectional view of the plug connector 100 showing the pin contact 110 loaded into the dielectric insert 112 and outer contact 114. The coupling nut 122 defines a chamber that receives a portion of the jack connector 200 (FIG. 1). The coupling nut 122 includes a lip 199 that engages a flange 172 to stop forward loading of the coupling nut 122 onto the plug housing 118. As shown, the lip 199 is captured between the flange 172 and a rim 190 of the rear housing 116 to axially position the coupling nut 122 with respect to the plug housing 118. The coupling nut 122 is rotatable with respect to the plug housing 118. The flange 172 limits forward movement of the coupling nut 122 and the rim 190 limits rearward movement of the coupling nut 122.

The dielectric insert 112 is inserted into the plug housing 118 through the rear 162. The structural features 146 engage the plug housing 118 to hold the dielectric insert 112 in the cavity 164 (FIG. 2) by an interference fit. In an exemplary embodiment, the rear 144 of the dielectric insert 112 is positioned forward of the rear 162 of the plug housing 118. The plug housing 118 is coupled to the rear housing 116.

The pin contact 110 is loaded along the contact axis 128 in a loading direction, shown by the arrow L. The pin contact 110 may be loaded into the outer contact 114 at any stage of the assembly process. For example, the pin contact 110 may be loaded into the dielectric insert 112 prior to the dielectric insert 112 being loaded into the plug housing 118. Alternatively, the pin contact 110 may be loaded into the dielectric insert 112 after the plug housing 118 and rear housing 116 are coupled together.

In the illustrated embodiment, the rear housing 116 is a one-piece body that includes a tube 188 and an interface body 189. A cavity in the tube 188 is open to a cavity in the interface body 189 to allow the coaxial cable 102 to extend into the cavity in the interface body 189 for termination to the pin contact 110. The center conductor 147 of the coaxial cable 102 is pressed into the pin contact 110 between the paddles 135. The paddles 135 make electrical connection with the pin contact 110. Optionally, the conductor 147 may be soldered to the pin contact 110 to make an electrical and mechanical connection with the pin contact 110. In an alternative embodiment, a secondary pin contact (not shown) may be terminated to the center conductor 147 and the secondary pin contact may be inserted into the pin contact 110 between the paddles 135 to make an electrical connection between the center conductor 147 and the pin contact 110. The tube 188 is sized to snuggly fit the coaxial cable 102 therein. The crimp barrel 126 provides a mechanical and/or electrical connection between the tube 188 and the coaxial cable 102. The crimp barrel 126 may provide strain relief.

FIG. 4 is a front exploded view of the jack connector 200. The jack connector 200 is configured to be electrically coupled with the plug connector 100 (FIG. 1). The jack connector 200 is configured to be mounted to the printed circuit board (PCB) 202. For example, the jack connector 200 may include a circuit board mount 215 and a board contact 209 to mechanically and electrically engage the PCB 202. In an exemplary embodiment, the board contact 209 and circuit board mount 215 are through-hole mounted to the PCB 202 by plugging the board contact 209 and the circuit board mount 215 into the signal via 205 and ground vias 206, respectively. However, the jack connector 200 may be terminated to the PCB 202 by alternative means, such as by surface mounting the board contact 209 and/or the circuit board mount 215 to the PCB 202.

The board contact 209 and the socket contact 210 are configured to be coupled together to define a signal path through the jack connector 200. The jack connector 200 includes a bottom dielectric insert 211 and a front dielectric insert 212 that hold the board contact 209 and/or the socket contact 210, respectively. The jack connector 200 includes an outer contact 214 that receives the dielectric inserts 211, 212 and the board and socket contacts 209, 210. The circuit board mount 215 and the outer contact 214 are electrically connected together and define a ground path or shield around the signal path.

The board contact 209 is mechanically and electrically connected to the socket contact 210 within the outer contact 214. The socket contact 210 is configured to be electrically connected to a center contact of a plug connector, such as the pin contact 110 (FIG. 2) of the plug connector 100 (FIG. 1). The outer contact 214 is configured to be electrically connected to the PCB 202, via the circuit board mount 215, to a ground conductor of the PCB 202.

In an exemplary embodiment, the outer contact 214 is a single-piece body having a rear housing portion 216 and a front housing portion 218 integrally formed together. In alternative embodiments, the outer contact 214 may be a multi-piece body with the pieces coupled together. The outer contact 214 has external threads 224 for securing the jack connector 200 to the plug connector 100. The rear housing portion 216 receives the bottom dielectric insert 211 to support the board contact 209.

The socket contact 210 extends along a contact axis 228 of the jack connector 200 between a separable interface at a mating end 230 and a non-separable terminating end 232. The contact axis 228 may be generally perpendicular to a contact axis 229 of the board contact 209. The mating end 230 is configured to be mated with the mating end 130 (FIG. 2) of the pin contact 110 (FIG. 2) of the plug connector 100 when the jack connector 200 is coupled thereto.

The terminating end 232 is configured to be terminated to the board contact 209. In an exemplary embodiment, the socket contact 210 has an open-sided barrel 234 at the terminating end 232. Optionally, the barrel 234 may be similar or identical to the barrel 134 (FIG. 2). The barrel 234 is configured to receive the board contact 209 to electrically connect the board contact 209 to the socket contact 210. In the illustrated embodiment, the board contact 209 defines a pin contact, however the board contact 209 may have other configurations in alternative embodiments. The board contact 209 includes a terminating end 233 that is received in the plated signal via 205 of the PCB 202 to electrically connect the board contact 209 to the PCB 202. The terminating end 233 may be a compliant section held in the signal via 205 by an interference fit. Optionally, the terminating end 233 may be soldered to the PCB 202.

In an exemplary embodiment, the barrel 234 includes a pair of paddles 235 opposing one another and separated by a gap 236. The board contact 209 is received in the gap 236 between the paddles 235. The paddles 235 press against the board contact 209 to create an electrical connection therewith.

The dielectric insert 212 has a bore 240 extending therethrough that receives and holds the socket contact 210. The dielectric insert 212 extends between a mating face 242 and a rear 244. The bore 240 extends entirely through the dielectric insert 212 between the mating face 242 and the rear 244. The bore 240 extends axially along the contact axis 228 of the jack connector 200.

The dielectric insert 212 is generally tubular in shape and includes a plurality of structural features 246 extending radially outward from an exterior of the tubular dielectric insert 212. Air gaps 248 are defined between the structural features 246. The structural features 246 serve to secure the dielectric insert 212 within the outer contact 214 by an interference fit therein. In an exemplary embodiment, the structural features 246 are tapered from a front 250 to a rear 252 of the structural features 246. In an exemplary embodiment, the size and shape of the structural features 246 are selected to provide a desired dielectric constant of the dielectric between the socket contact 210 and the outer contact 214.

The outer contact 214 extends between a front 260 and a rear 262. The outer contact 214 has a bottom 263. The bottom 263 is configured to be mounted to the PCB 202. The bottom 263 is oriented generally perpendicular with respect to the front 260 and the rear 262. The circuit board mount 215 is coupled to the bottom 263. The outer contact 214 has a cavity 264 extending between the front 260 and the rear 262. The cavity 264 extends to the bottom 263. The cavity 264 turns 90° within the outer contact 214 to create a path between the front 260 and the bottom 263. In an exemplary embodiment, the front 260 of the outer contact 214 defines a separable interface end 266 of the outer contact 214. The bottom 263 of the outer contact 214 defines a terminating end 268 of the outer contact 214. The terminating end 268 is oriented generally perpendicular with respect to the separable interface end 266.

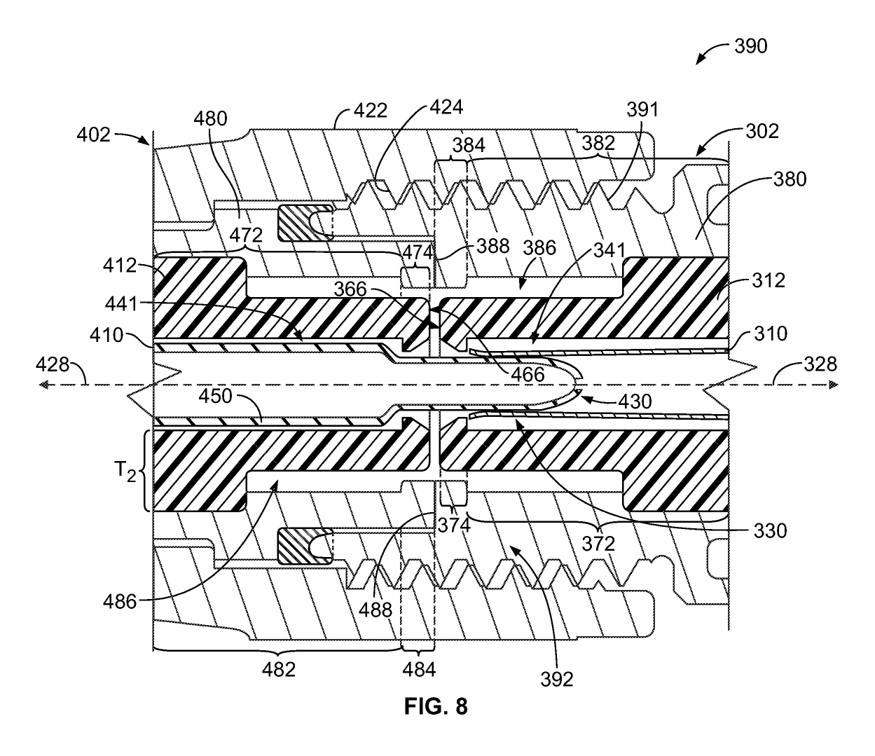

FIG. 5 is a side cross-section of the jack connector 200 showing the socket contact 210 loaded in the dielectric insert 212 and outer contact 214. The board contact 209 is loaded in the dielectric insert 211 and engages the socket contact 210. The plug connector 100 (FIG. 1) and the jack connector 200 are configured to mate with each other at a mating interface. The mating interface may be similar to the mating interface 392 that is described below with respect to FIG. 8. More specifically, the pin contact 110 (FIG. 1) may be received by and engage the socket contact 210 to establish a signal path through the connector system formed by the plug and jack connectors 100, 200. The outer contact 114 (FIG. 2) and the outer contact 214 may engage each other and establish a return path of the connector system. Moreover, the dielectric insert 212 may be shaped similar to the dielectric insert 312 (shown in FIG. 8) to protect the socket contact 210.

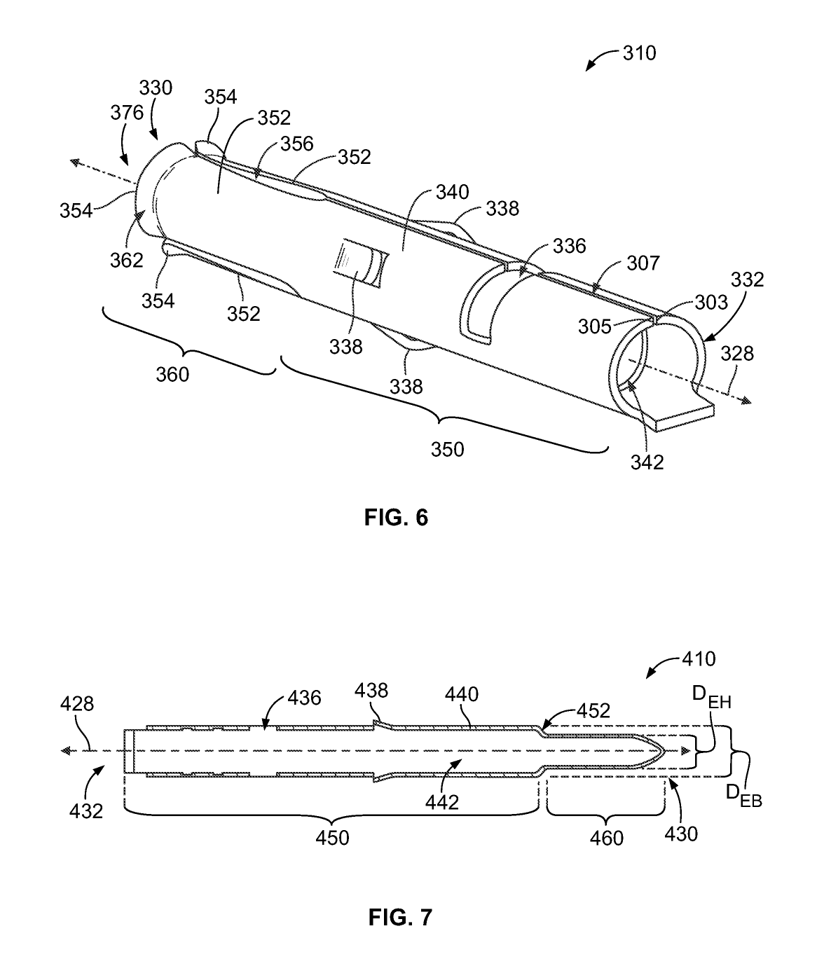

FIG. 6 is a perspective view of a socket contact 310 formed in accordance with one embodiment. The socket contact 310 includes a mating end 330, a terminating end 332, and a central contact axis 328 extending therebetween. The socket contact 310 includes a contact wall 340 that extends around the contact axis 328 to define a contact cavity 342. As shown, the socket contact 310 may include a barrel or body portion 350 and a plurality of socket beams 352 that extend from the barrel portion 350 along the contact axis 328 toward the mating end 330. In the illustrated embodiment, the socket contact 310 includes three socket beams 352. However, other embodiments may include two socket beams or more than three socket beams.

In an exemplary embodiment, the socket contact 310 is stamped-and-formed. For instance, the contact wall 340 may be stamped from a conductive sheet of material (e.g., copper) and formed (e.g., rolled, bent, and the like) to include the various features described herein. The socket contact 310 may include stamped edges 303, 305 that extend alongside each other at a contact seam 307 when the socket contact 310 is formed. Before or after the contact wall 340 is stamped-and-formed, the contact wall 340 may be plated or finished with other material (e.g., gold). In alternative embodiments, the socket contact 310 is not stamped-and-formed but manufactured through other processes (e.g., screw-machining or die-casting).

In some embodiments, the barrel portion 350 corresponds to a portion of the socket contact 310 that is configured to be held by a dielectric insert, such as the dielectric insert 312 shown in FIG. 8 below. For example, the barrel portion 350 (or features thereof) may directly engage the dielectric insert 312 and form an interference fit with the dielectric insert 312. Also shown, the barrel portion 350 may include a gap or opening 336 that is configured to receive a conductor (not shown) from, for example, a cable (not shown). The barrel portion 350 may also include locking tabs 338 that are angled to extend radially away from the contact axis 328. The locking tabs 338 are deflectable and may function to secure the socket contact 310 in the dielectric insert 312.

The contact wall 340 defines a wall edge 376 at the mating end 330. The socket beams 352 may define portions or segments of the wall edge 376. As shown in FIG. 6, the socket beams 352 are distributed about the contact axis 328 and are separated from each other by corresponding slots 356. The socket beams 352 extend to respective edge segments 354 at the mating end 330. The edge segments 354 define portions of the wall edge 376. Also shown in FIG. 6, the socket beams 352 are angled radially-inward toward the contact axis 328 as the socket beams 352 extend from the barrel portion 350 to the mating end 330. However, in alternative embodiments, the socket beams 352 may extend parallel to the contact axis 328 from the barrel portion 350.

The socket beams 352 include respective base portions 360 and distal portions 362. The distal portions include the edge segments 354. The base portions 360 are joined to and extend from the barrel portion 350. In an exemplary embodiment, the base portions 360 are angled radially-inward toward the contact axis 328 as the base portion 360 extends from the barrel portion 350 to the respective distal portion 362. The distal portions 362 may be shaped to extend radially-outward from the contact axis 328 as the distal portions 362 extend from the respective base portions 360 to the edge segments 354. As such, the distal portions 362 may have a flared arrangement.

FIG. 7 is a side cross-section of a pin contact 410 formed in accordance with one embodiment. The pin contact 410 includes a mating end 430, a terminating end 432, and has a contact axis 428 that extends between the mating and terminating ends 430, 432. As shown, the pin contact 410 may have a barrel section 450 that includes the terminating end 432, and a head section 460 that includes the mating end 430. Also shown in FIG. 7, the barrel section 450 may include locking tabs 438 and a gap 436 that are similar to the locking tabs 338 and the gap 336, respectively, of the socket contact 310 shown in FIG. 6. The head section 460 is configured to be received by the socket contact 310 (FIG. 6). As shown, the head section 460 has a curved shape at the mating end 430. The curved shape may facilitate directing the pin contact 410 into alignment with the socket contact 310.

The barrel and head sections 450, 460 may have different cross-sectional dimensions. For example, both of the barrel and head sections 450, 460 may have substantially circular cross-sections taken perpendicular to the contact axis 428. The cross-sections may be concentric with respect to the contact axis 428. However, the cross-section of the barrel section 450 is greater in size than the cross-section of the head section 460. More specifically, the pin contact 410 is shaped such that the barrel section 450 has an external diameter D_{EB} that is greater than an external diameter D_{EH} of the head section 460. An external diameter is measured from one point on an exterior surface of the pin contact 410 to another point on an exterior surface. The pin contact 410 may include a tapering joint 452 that joins the barrel and head sections 450, 460. The tapering joint 452 is configured to transition the pin contact 410 from the dimensions of the barrel section 450 to the dimensions of the head section 460. For example, in the illustrated embodiment, the tapering joint 452 transitions from the external diameter D_{EB} to the external diameter D_{EH}.

Like the socket contact 310, the pin contact 410 may also be stamped-and-formed from a conductive sheet of material. In such embodiments, a contact wall 440 may be stamped from the conductive sheet and then formed (e.g., bent, rolled, and the like) to provide the various features of the pin contact 410. When the pin contact 410 is formed, the contact wall 440 may define a contact cavity 442 of the pin contact 410. However, in alternative embodiments, the pin contact 410 is manufactured through other processes.

FIG. 8 is a side cross-section of a coaxial connector system 390 formed in accordance with one embodiment. The connector system 390 includes a first coaxial connector 302 and a second coaxial connector 402. FIG. 8 only shows portions of the coaxial connectors 302, 402. Nonetheless, the coaxial connector 302 may have similar components and structures as the jack connector 200 (FIG. 1), and the coaxial connector 402 may have similar components and structures as the plug connector 100 (FIG. 1).

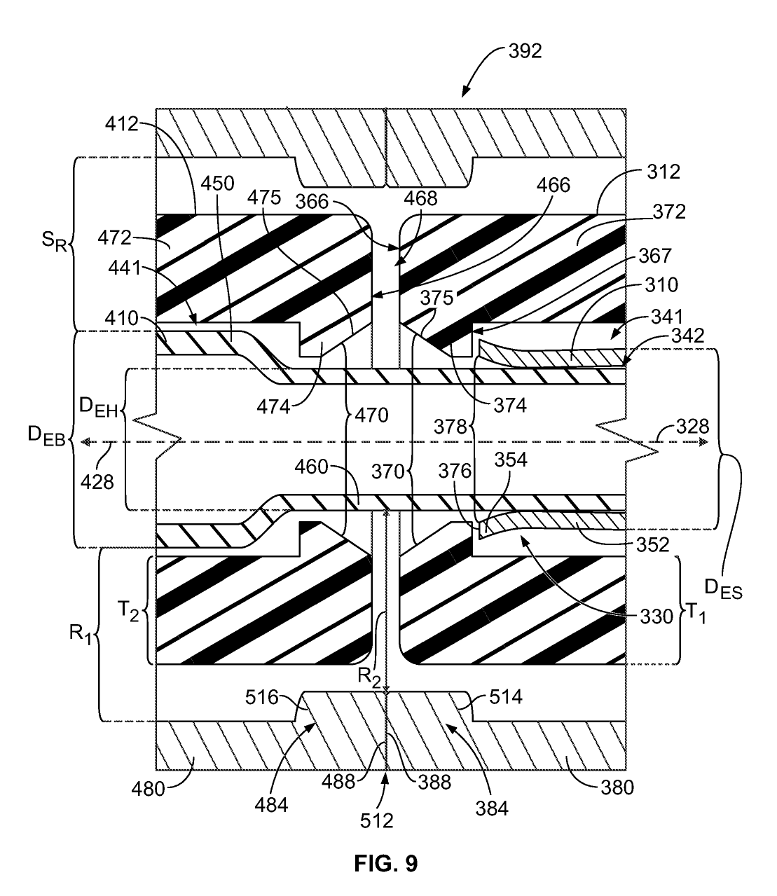

The coaxial connector 302 includes the socket contact 310, and the coaxial connector 402 includes the pin contact 410. As shown in FIG. 8, the coaxial connectors 302, 402 are mated together in a mated engagement. In the mated engagement, the coaxial connectors 302, 402 are mechanically secured to prevent inadvertent disengagement and the socket and pin contacts 310, 410 are mechanically and electrically engaged such that data signals may be transmitted therethrough between the coaxial connectors 302, 402. In the illustrated embodiment, the contact axes 428, 328 are aligned with each other when the coaxial connectors 302, 402 are in the mated engagement such that the contact axes 428, 328 coincide. Thus, the contact axes 428, 328 appear to be one axis in FIG. 8 and also in FIG. 9.

The coaxial connector 302 includes a first dielectric insert 312 having a mating face 366. The mating face 366 faces in a direction that is along the contact axis 328 (or the contact axis 428). The dielectric insert 312 includes a central bore 341 that is configured to receive and hold the socket contact 310. The bore 341 extends along the contact axis 328 and also along the contact axis 428 when the coaxial connectors 302, 402 are in the mated engagement. Although not identical, the dielectric insert 312 may have a similar structure as the dielectric insert 212 (FIG. 4) and may function in the same manner.

The dielectric insert 312 includes a body portion 372 and a hood portion 374. The entire body portion 372 is not shown in FIG. 8. The body and hood portions 372, 374 may have different cross-sectional dimensions. The body portion 372 may correspond to the portion of the dielectric insert 312 that surrounds the socket contact 310 in the bore 341. In the illustrated embodiment, the bore 341 has a uniform cross-section throughout the body portion 372. The body portion 372 and the hood portion 374 are immediately adjacent to each other.

The coaxial connector 302 also includes a first outer contact 380 that surrounds the dielectric insert 312 and the socket contact 310. The outer contact 380 may have similar features as the outer contact 214 (FIG. 4) or the outer contact 114 (FIG. 2). The outer contact 380 defines a main cavity 386 where the dielectric insert 312 and the socket contact 310 are located. As shown, the outer contact 380 includes a main portion 382 and an end portion 384. The entire main portion 382 is not shown in FIG. 8. The main portion 382 may correspond to the portion of the outer contact 380 that surrounds the socket contact 310. The end portion 384 generally corresponds to the portion of the outer contact 380 that surrounds the hood portion 374 of the dielectric insert 312. The end portion 384 includes a separable interface end 388. The interface end 388 faces in a direction that is generally along the contact axis 328. In the illustrated embodiment, the outer contact 380 includes external threads 391.

The coaxial connector 402 includes a second dielectric insert 412 having a mating face 466 and the pin contact 410 that is held by the dielectric insert 412. The dielectric insert 412 includes a central bore 441 that is configured to receive and hold the socket contact 410. Although not identical, the dielectric insert 412 may have a similar structure as the dielectric insert 112 (FIG. 2) and function in the same manner. Like the dielectric insert 312, the dielectric insert 412 includes a body portion 472 and a hood portion 474. In the illustrated embodiment, the body portion 472 and the hood portion 474 are immediately adjacent to each other.

The coaxial connector 402 also includes a second outer contact 480 that surrounds the dielectric insert 412 and the pin contact 410. The outer contact 480 defines a main cavity 486 where the dielectric insert 412 and the pin contact 410 are located. As shown, the outer contact 480 includes a main portion 482 and an end portion 484. The main portion 482 may correspond to the portion of the outer contact 480 that generally surrounds the barrel section 450 of the pin contact 410. The end portion 484 includes a separable interface end 488 and generally corresponds to the portion of the outer contact 480 that surrounds the hood portion 474 of the dielectric insert 412. The interface end 488 faces in a direction that is generally along the contact axis 428.

In the illustrated embodiment, the coaxial connector 402 also includes a coupling member 422. The coupling member 422 may be similar to the coupling nut 122 (FIG. 2). The coupling member 422 extends around the outer contact 480 and includes internal threads 424 that are configured to engage the external threads 391 of the outer contact 380. However, in other embodiments, the coaxial connector 302 includes a coupling member having internal threads that engage external threads of the outer contact 480.

FIG. 9 illustrates in greater detail the positioning of the various components of the coaxial connectors 302, 402 (FIG. 8) at the mating interface 392. As shown, the mating face 366 includes an insert opening 370 that provides access to the bore 341 and the socket contact 310 therein. The hood portion 374 may correspond to the portion of the dielectric insert 312 that surrounds and defines the insert opening 370.

The hood portion 374 projects radially inward from the body portion 372 toward the contact axis 328. In the illustrated embodiment, the insert opening 370 does not have a uniform cross-section. For instance, the insert opening 370 is defined by an angled surface 375 that extends between the mating face 366 and a loading face 367. The loading face 367 is a rearward-facing surface that partially defines the bore 341. The angled surface 375 forms a non-orthogonal angle with respect to the contact axis 328. For example, the angled surface 375 may be chamfered, beveled, or funnel-shaped.

The hood portion 374 may cover the wall edge 376 of the socket contact 310 at the mating end 330. The loading face 367 faces the wall edge 376. In the illustrated embodiment, the wall edge 376 is defined by the separate edge segments 354 of the socket beams 352 and extends circumferentially around the contact axis 328. Thus, in some embodiments, the wall edge 376 has breaks or gaps (i.e., the wall edge 376 may be circumferentially non-continuous) which are defined by the slots 356 (FIG. 6) that separate the socket beams 352. In other embodiments, the wall edge 376 extends continuously around the contact axis 328. The wall edge 376 defines a contact opening 378 that provides access to the contact cavity 342.

Also shown, the mating face 466 faces the mating face 366 with a nominal dielectric air gap 468 therebetween. For example, the dielectric inserts 312, 412 may be dimensioned to have the air gap 468 therebetween so that manufacturing tolerances do not permit the dielectric inserts 312, 412, in some cases, to clear the outer contacts 380, 480, respectively. The mating face 466 includes an insert opening 470 that provides access to the bore 441 and the pin contact 410 therein. The hood portion 474 may correspond to the portion of the dielectric insert 412 that surrounds and defines the insert opening 470. Similar to the hood portion 374, the hood portion 474 projects radially inward from the body portion 472 toward the contact axis 428. The hood portion 474 may directly surround the head section 460 of the pin contact 410 such that the hood portion 474 touches or nearly touches the head section 460. As shown, the insert opening 470 does not have a uniform cross-section, but may have a uniform cross-section in other embodiments. For example, the insert opening 470 may be defined by an angled surface 475 that is similar to the angled surface 375. In the illustrated embodiment, the insert opening 470 has a similar funnel-shape as the insert opening 370.

When the coaxial connectors 302, 402 (FIG. 8) are in the mated engagement, the outer contacts 380, 480 are engaged and electrically coupled to each other at an outer interface 512. More specifically, the interface ends 388, 488 of the end portions 384, 484, respectively, are engaged to each other at the outer interface 512. The electrical connection between the outer contacts 380, 480 may provide a ground or return path for the connector system 390 (FIG. 8).

The end portions 384, 484 include contact rims 514, 516, respectively, that project radially inward toward the socket and pin contacts 310, 410. The contact rims 514, 516 circumferentially surround the head section 460 of the pin contact 410. The contact rims 514, 516 are associated with a reduced cross-section of the electrical connection between the pin and socket contacts 410, 310. More specifically, the head section 460 has the external diameter D_{EH} and the barrel section 450 has the external diameter D_{EB}. When the pin and socket contacts 410, 310 are in the mated engagement, the socket contact 310 may have an external diameter D_{ES} that is substantially equal to the external diameter D_{EB}. Thus, the contact rims 514, 516 are positioned to extend circumferentially around the reduced cross-section of the head section 460.

Due to the change in the dimensions of the conductive pathway (i.e., the pin and socket contacts 410, 310 mated together), the electrical performance of the connector system 390 may be affected. More specifically, an impedance of the connector system 390 at the mating interface 392 may be increased. Accordingly, the contact rims 514, 516 may be configured to balance the impedance. As shown in FIG. 9, a radial space S_{R} exists between the outer contacts 380, 480 and the socket and pin contacts 310, 410, respectively. The radial space S_{R} extends annularly around the pin and socket contacts 410, 310 (and the contact axes 428, 328) and includes air and/or dielectric material from the dielectric inserts 312, 412. Embodiments described herein may be configured to maintain the radial space S_{R} so that a size of the radial space S_{R} is uniform throughout the mating interface 392 even though dimensions of the pin and socket contacts 410, 310 may change. For example, a radial distance R₁ between the barrel section 450 of the pin contact 410 and the outer contact 480 may be substantially equal to a radial distance R₂ between the head section 460 and the contact rims 514, 516.

Embodiments may also be configured to balance impedance through the mating interface 392. For example, dimensions of the dielectric inserts 312, 412 in the radial space S_{R} may be configured to obtain a substantially uniform target impedance through the mating interface 392. Through the mating interface 392, electrical current may propagate in a direction along the contact axes 428, 328 from the terminating end 432 (FIG. 7) of the pin contact 410 to the mating end 430 of the pin contact 410 (or the mating end 330 of the socket contact 310) and to the terminating end 332 (FIG. 6) of the socket contact 310. The electrical current may also propagate in the opposite direction along the electrical path from the terminating end 332 to the terminating end 432. As shown, the dielectric inserts 312, 412 have respective radial thicknesses T₁, T₂. The external diameter D_{EB} of the barrel section 450, the external diameter D_{EB} of the head section 460, the external diameter D_{ES} of the socket contact 310, the thicknesses T₁, T₂, and the contact rims 514, 516 may be configured relative to one another to achieve a substantially uniform target impedance throughout the mating interface 392. More specifically, when dimensions of the conductive pin and socket contacts 410, 310 change along the electrical path as shown in FIG. 9, then a combination of air, dielectric material from the dielectric inserts 312, 412, and metal in the outer contacts 380, 480 (FIG. 8) may be adjusted in the radial space S_{R} to maintain the target impedance throughout. By way of example, the target impedance may be about 50+/−1 ohm at a frequency of at least about 18 GHz. In some cases, the target impedance may be about 50+/−0.5 ohms at a frequency greater than 18 GHz.

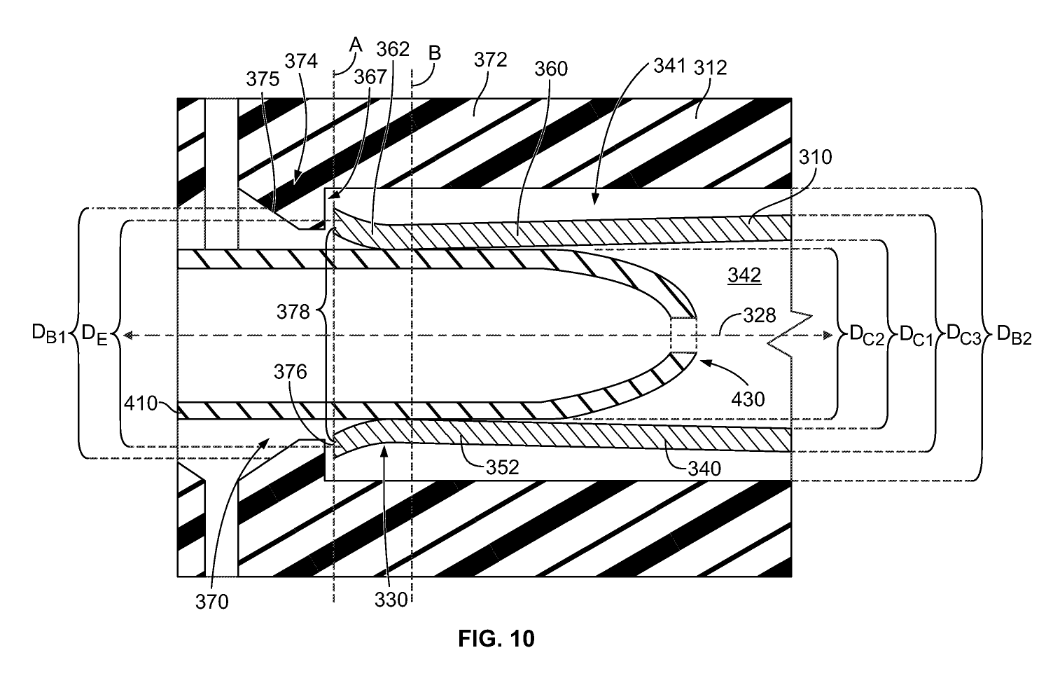

FIG. 10 shows the socket contact 310 and the pin contact 410 in the mated engagement. The hood portion 374 is configured to direct the pin contact 410 into the contact cavity 342 when the pin contact 410 engages the hood portion 374. As shown, the hood portion 374 defines a diameter D_{B1} of the insert opening 370, and the body portion 372 defines a diameter D_{B2} of the bore 341. The diameter D_{B1} is defined by the angled surface 375. The angled surface 375 is configured to direct the pin contact 410 toward the contact opening 378 of the socket contact 310 if the mating end 430 of the pin contact 410 engages the angled surface 375. Thus, the diameter D_{B1} decreases as the hood portion 374 extends toward the socket contact 310. In the illustrated embodiment, the diameter D_{B2} is substantially uniform for that portion of the dielectric insert 312 that holds the socket contact 310. In particular embodiments, the diameter D_{B1} immediately before the pin contact 410 clears the hood portion 374 (i.e., the edge formed between the angled surface 375 and the rearward-facing surface 367) is less than the diameter D_{B2} immediately after the pin contact 410 clears the hood portion 374 (or clears the rearward-facing surface 367).

Also shown, the contact wall 340 defines first and second diameters D_{C1}, D_{C2} of the contact cavity 342 that are measured perpendicular to the contact axis 328. The first diameter D_{C1} is taken proximate to the mating end 330 and may be associated with the distal portions 362 of the socket beams 352. More specifically, the first diameter D_{C1} may correspond to a cross-sectional plane A shown in FIG. 10 that is taken perpendicular to the contact axis 328. The second diameter D_{C2} is located a distance from the wall edge 376 and may correspond to a cross-sectional plane B shown in FIG. 10. The cross-sectional plane B is located where the base portions 360 join the corresponding distal portions 362. The cross-sectional plane B is taken perpendicular to the contact axis 328 and is the approximate location where the socket beam 352 changes direction with respect to the contact axis 328. For example, as the socket beam 352 is extending toward the mating end 330, the socket beam 352 changes from being angled toward the contact axis 328 to being angled away from the contact axis 328. The second diameter D_{C2} of the contact cavity 342 taken along the cross-sectional plane B may represent a smallest diameter of the contact cavity 342 defined by the socket beams 352.

The contact wall 340 is shaped such that the first diameter D_{C1} proximate to the mating end 330 decreases as the contact wall 340 extends along contact axis 328 from the wall edge 376 toward the terminating end 332 (FIG. 6). More specifically, the socket beams 352 are shaped such that the first diameter D_{C1} decreases as the socket beams 352 extend from the wall edge 376 to the cross-sectional plane B. The first diameter D_{C1} is sized to permit the mating end 430 of the pin contact 410 to move freely through the contact opening 378.

However, the second diameter D_{C2} is sized such that the contact wall 340 engages the pin contact 410 as the pin contact 410 is inserted through the contact opening 378 and into the contact cavity 342. In the illustrated embodiment, the bore 341 is sized and shaped relative to the socket contact 310 such that the socket beams 352 are permitted to flex away from the contact axis 328 in the bore 341. FIG. 10 shows the socket beams 352 in an engaged (or deflected) position. In such embodiments, the diameter D_{B2} of the bore 341 is sized to be greater than an external diameter D_{C3} of the socket beams 352 to allow the socket beams 352 to be deflected.

Also shown in FIG. 10, the wall edge 376 may define an edge diameter D_{E}. The edge diameter D_{E} is configured to be greater than the diameter D_{B1} of the insert opening 370 where the pin contact 410 clears the insert opening 370. More specifically, the diameter D_{B1} immediately before the pin contact 410 clears the hood portion 374 is less than the edge diameter D_{E}. The wall edge 376 is located immediately behind the hood portion 374 such that the wall edge 376 may touch or nearly touch the rearward-facing surface 367. As such, the hood portion 374 not only directs the pin contact 410 toward the contact opening 378 during a mating operation, but also protects the socket contact 310 and prevents stubbing of the wall edge 376 by the pin contact 410.

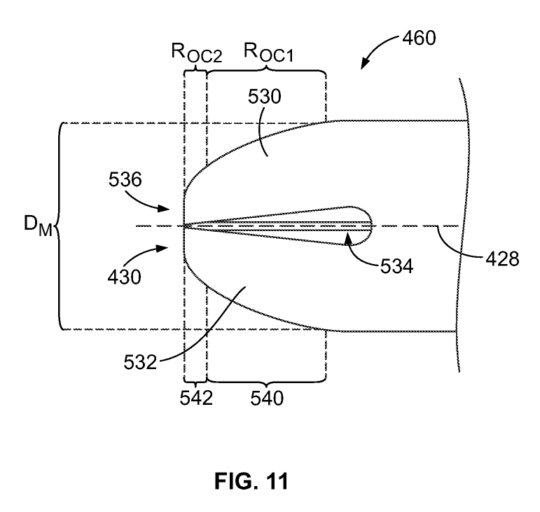

FIG. 11 is a side view of a portion of the head section 460 of the pin contact 410 (FIG. 7) that includes the mating end 430. As described above, the pin contact 410 may be stamped-and-formed. In the illustrated embodiment, the pin contact 410 includes a plurality of end tabs 530, 532 and a tab slot 534 therebetween. When the sheet material is stamped, the tab slot 534 is formed and separates the end tabs 530, 532. The tab slot 534 is dimensioned to permit the end tabs 530, 532 to be shaped to have a curved contour as shown in FIG. 11.

The head section 460 has first and second head portions 540, 542 proximate to the mating end 430. The first head portion 540 is located between the barrel section 450 (FIG. 7) and the second head portion 542. The pin contact 410 at the mating end 430 may have a contact diameter D_{M} that decreases at a non-linear rate toward a distal tip 536 through the first and second head portions 540, 542 of the pin contact 410. For example, as shown in FIG. 11, a slope of the mating end 430 may have a first radius of curvature R_{OC1} at the head portion 540 and a second radius of curvature R_{OC2} at the head portion 542. The first radius of curvature R_{OC1} is greater than the second radius of curvature R_{OC2}. In other words, the second radius of curvature R_{OC2} has a sharper curve toward the central axis 428. The mating end 430 has the second radius of curvature R_{OC2} until the distal tip 536. The distal tip 536 may be substantially flat and extend perpendicular to the contact axis 428. Accordingly, the contact diameter D_{M} along the first head portion 540 decreases at a lesser rate than along the second head portion 542.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A coaxial connector comprising:
a socket contact having a mating end, a terminating end, and a central contact axis extending therebetween, the socket contact including a contact wall that extends around the contact axis and defines a contact cavity, wherein the contact wall has a wall edge at the mating end that defines a contact opening to the contact cavity, the contact cavity configured to receive a pin contact of a mating connector through the contact opening; and
a dielectric insert having a central bore that receives and holds the socket contact, the dielectric insert including a mating face that has an insert opening providing access to the bore, the dielectric insert including a body portion that surrounds the socket contact and a hood portion that defines the insert opening, the hood portion projecting radially inward from the body portion toward the contact axis so that the hood portion covers the wall edge, the hood portion configured to direct the pin contact into the contact cavity.

2. The coaxial connector of claim 1, wherein the hood portion around the insert opening is shaped to direct the pin contact toward the contact opening as the pin contact is moved along the contact axis in a misaligned manner, the hood portion preventing the pin contact from stubbing the wall edge.

3. The coaxial connector of claim 1, wherein the hood portion defines a diameter of the insert opening and the body portion defines a diameter of the bore, wherein the diameter of the insert opening immediately before the pin contact clears the hood portion is less than the diameter of the bore immediately after the pin contact clears the hood portion.

4. The coaxial connector of claim 1, wherein the contact wall defines a diameter of the contact cavity, the diameter of the contact cavity decreasing as the contact wall extends along the contact axis from the wall edge.

5. The coaxial connector of claim 1, wherein the contact wall defines first and second diameters of the contact cavity, the first diameter being located at the wall edge and the second diameter being located a distance from the wall edge, wherein the first diameter is sized to permit the pin contact to move freely through the contact opening and the second diameter is sized less than the first diameter such that the contact wall will engage the pin contact.

6. The coaxial connector of claim 1, wherein the hood portion defines a diameter of the insert opening and the socket contact has an edge diameter at the wall edge, wherein the diameter of the insert opening immediately before the pin contact clears the hood portion is less than the edge diameter.

7. The coaxial connector of claim 1, wherein the contact wall is stamped from a conductive sheet of material and formed to include a barrel portion and socket beams that extend from the barrel portion along the contact axis, the socket beams extending to the mating end and defining portions of the wall edge.

8. The coaxial connector of claim 7, wherein the socket beams extend radially-inward toward the contact axis as the socket beams extend from the barrel portion to the mating end.

9. The coaxial connector of claim 7, wherein the bore of the dielectric insert and the socket beams are dimensioned such that the socket beams are permitted to flex away from the contact axis when the socket beams engage the pin contact.

10. The coaxial connector of claim 1, further comprising an outer contact including a main cavity that has the dielectric insert and the socket contact disposed therein, the outer contact having an interface end configured to engage the mating connector, wherein the outer contact includes a main portion and an end portion that has the interface end, the end portion including a contact rim that projects radially inward from the main portion toward the contact axis.

11. A coaxial connector comprising:
a pin contact having a mating end, a terminating end, and a central contact axis extending therebetween, the pin contact including a barrel section and a head section of the pin contact, the head section configured to be received by a socket contact of a mating connector;
a dielectric insert including a central bore that receives and holds the pin contact, the dielectric insert having a mating face that includes an insert opening that provides access to the bore, the head section of the pin contact extending through the insert opening and projecting away from the mating face along the contact axis, wherein the dielectric insert includes a body portion that surrounds the pin contact and a hood portion that defines the insert opening, the hood portion projecting radially inward from the body portion toward the contact axis, the hood portion directly surrounding the head section of the pin contact.

12. The coaxial connector of claim 11, wherein the pin contact is shaped such that the barrel section has an external diameter that is greater than an external diameter of the head section.

13. The coaxial connector of claim 11, wherein the head section includes first and second head portions, the first head portion being located between the barrel section and the second head portion, wherein the first head portion has a radius of curvature and the second head portion has a radius of curvature, the first radius of curvature being greater than the second radius of curvature.

14. The coaxial connector of claim 11, wherein the pin contact is stamped-and-formed from a conductive sheet of material.

15. A coaxial connector system comprising:
a first coaxial connector comprising a first dielectric insert having a mating face and a socket contact that is held by the first dielectric insert, the mating face including an insert opening that provides access to the socket contact, the first coaxial connector also including a first outer contact that surrounds the first dielectric insert and the socket contact, wherein the first outer contact includes a main portion and an end portion; and
a second coaxial connector comprising a second dielectric insert having a mating face and a pin contact that is held by the second dielectric insert, the second coaxial connector also including a second outer contact that surrounds the second dielectric insert and the pin contact, wherein the second outer contact includes a main portion and an end portion;
wherein the socket contact is configured to receive and engage the pin contact when the first and second coaxial connectors are mated, the end portions of the first and second outer contacts engaging and electrically coupling to each other at an outer interface, wherein the end portions include respective contact rims that project radially inward, wherein the contact rims are configured relative to the pin and socket contacts and the first and second dielectric inserts to maintain a target impedance.

16. The connector system of claim 15, wherein the pin contact includes a barrel section and a head section, the head section including a mating end of the pin contact that is received by the socket contact, wherein the barrel section has an external diameter that is greater than an external diameter of the head section, the contact rims circumferentially surrounding the head section of the pin contact.

17. The connector system of claim 16, wherein the socket contact has an external diameter when the pin and socket contacts are engaged, the external diameter of the socket contact being substantially equal to the external diameter of the barrel section of the pin contact.

18. The connector system of claim 15, wherein the pin contact includes a barrel section and a head section, the head section including a mating end of the pin contact that is received by the socket contact, wherein the barrel section has an external diameter that is greater than an external diameter of the head section.

19. The connector system of claim 15, wherein the mating faces of the first and second dielectric inserts face each other with a nominal dielectric air gap therebetween.

20. The connector system of claim 15, wherein the first dielectric insert is shaped around the insert opening to direct the pin contact into the socket contact when the pin contact engages the first dielectric insert.
